(19) United States
(12) Patent Application Publication
(10) Pub. No.: US 2015/0089047 A1
(43) Pub. Date: Mar. 26, 2015

(54) CUT-THROUGH PACKET MANAGEMENT

(71) Applicant: Broadcom Corporation, Irvine, CA (US)

(72) Inventors: William Brad Matthews, San Jose, CA (US); Puneet Agarwal, Cupertino, CA (US)

(73) Assignee: Broadcom Corporation, Irvine, CA (US)

(21) Appl. No.: 14/042,263

(22) Filed: Sep. 30, 2013

Related U.S. Application Data
(60) Provisional application No. 61/880,492, filed on Sep. 20, 2013.

(51) Int. Cl. H04L 12/26

(52) U.S. Cl. CPC H04L 43/0823
USPC 709/224

(57) ABSTRACT

Disclosed are various embodiments that relate identifying a source of corruption in a network made up of multiple network nodes. A network node is configured to provide corruption source identification while handling packets according to a cut-through scheme. According to some embodiments, a network node may perform a running error detection operation on a cut-through packet and then insert a debug indicator into the cut through packet. In other embodiments, the network node may process some packets according to a cut-through scheme while process other packets according to a store-and-forward scheme to detect packet corruption in a network.

### CROSS REFERENCE TO RELATED PATENTS/PATENT APPLICATIONS

The present application claims the benefit of and priority to co-pending U.S. Provisional patent application titled, “Cut-Through Packet Management”, having Ser. No. 61/880,492, filed Sep. 20, 2013, which is hereby incorporated by reference herein in its entirety for all purposes.

### BACKGROUND

A collection of servers may be used to create a distributed computing environment. The servers may process multiple applications by receiving data inputs and generating data outputs. Network switches may be used to route data from various sources and destinations in the computing environment. For example, a network switch may receive network packets from one or more servers and/or network switches and route the packets to other servers and/or network switches. It may be the case that, as a packet is transmitted from one switch to another, the packet becomes corrupted. Corruption may be caused by faulty wiring in the network, electromagnetic interference, data noise introduced by a switch, or any other undesired network abnormality.

### BRIEF DESCRIPTION OF THE DRAWINGS

Many aspects of the present disclosure can be better understood with reference to the following drawings. The components in the drawings are not necessarily drawn to scale, emphasis instead being placed upon clearly illustrating the principles of the disclosure. Moreover, in the drawings, like reference numerals designate corresponding parts throughout the several views.

FIG. 1 is a drawing of a computing environment, according to various embodiments of the present disclosure.

FIGS. 2A-2E are drawings of examples of a cut-through type packet that is transmitted via the computing environment 100 of FIG. 1, according to various embodiments of the present disclosure.

FIG. 3 is a drawing of an example of a network node in the computing environment of FIG. 1, according to various embodiments of the present disclosure.

FIGS. 4 and 5 are drawings of examples of data included in a packet transmitted via the computing environment 100 of FIG. 1, according to various embodiments of the present disclosure.

FIG. 6 is a flowchart illustrating one example of functionality implemented as portions of the processing circuitry in the network node in the computing environment of FIG. 1, according to various embodiments of the present disclosure.

FIG. 7 is a flowchart illustrating another example of functionality implemented as portions of the processing circuitry that uses a packet scheme selector in the network node in the computing environment of FIG. 1, according to various embodiments of the present disclosure.

### DETAILED DESCRIPTION

The present disclosure relates to debugging a packet is switched through a network made up of multiple nodes. As the packet is transmitted along a route, the packet may become corrupted. Various embodiments of the present disclosure allow for the identification of the source of corruption when the packet is transmitted along a multi-hop path.

Some packets may be handled as a store-and-forward packet (SAF packet) or a cut-through packet (CT packet). An SAF packet is a packet that is switched from one network node to another. At each network node, the entire SAF packet is received, stored, processed, and then forwarded to the next network node. Because an entire SAF packet is received by a network node before the SAF packet is forwarded, it may be relatively easy to identify the instant when an SAF is subjected to corruption using error detection and correction logic contained in each packet. A CT packet is a packet that is received by a particular network node and then forwarded to the next network node before the particular network node completely receives the CT packet. That is to say, a network node begins forwarding a beginning portion of a CT packet while or before the network node receives an end portion of the CT packet. In this respect, it may be the case that, at a single point in time, a CT packet is handled by multiple network nodes. Since error-detection is typically performed by a network node after receiving the last-bit, it may be difficult to detect an error prior to the start of packet transmission. The present disclosure allows for the identification of the source of corruption for a network that handles packets as CT packets.

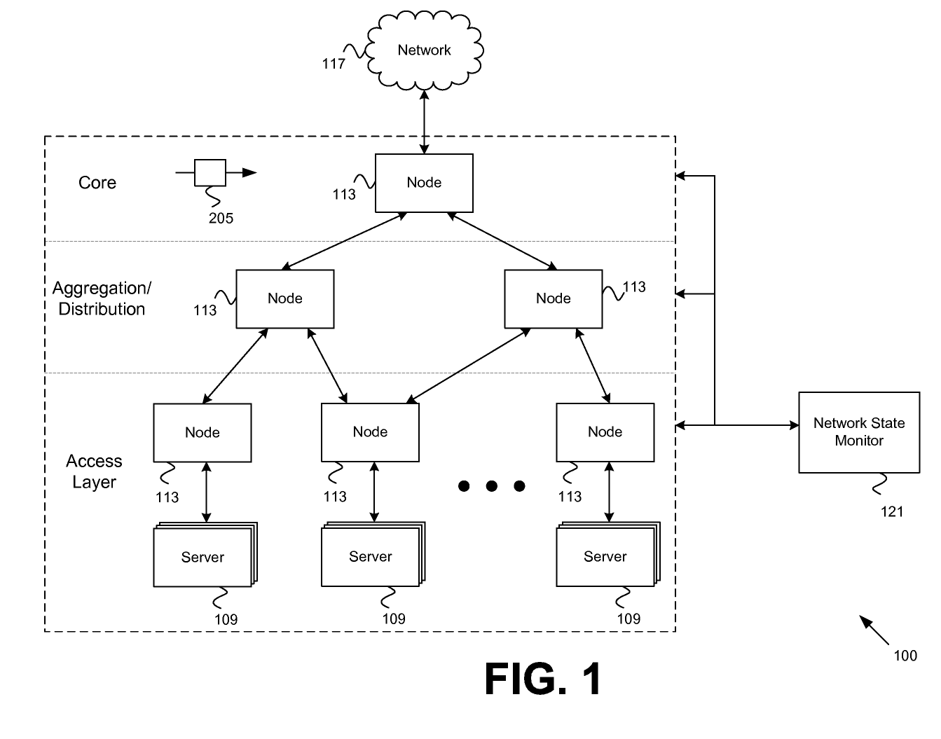

With reference to FIG. 1, shown is an example of computing environment 100. The computing environment 100 may comprise a private cloud, a data warehouse, a server farm, or any other collection of computing devices that facilitate distributed computing. The computing environment 100 may be organized in various functional levels. For example, the computing environment 100 may comprise an access layer, an aggregation/distribution layer, a core layer, or any other layer that facilitates distributed computing.

The access layer of the computing environment 100 may comprise a collection of computing devices such as, for example, servers 109. A server 109 may comprise one or more server blades, one or more server racks, or one or more computing devices configured to implement distributed computing.

To this end, a server 109 may comprise a plurality of computing devices that may be arranged, for example, in one or more server banks, computer banks, or other arrangements. For example, the server 109 may comprise a cloud computing resource, a grid computing resource, and/or any other distributed computing arrangement. Such computing devices may be located in a single installation. A group of servers 109 may be communicatively coupled to a network node 113. The network node 113 may relay input data to one or more servers 109 and relay output data from one or more servers 109. A network node 113 may comprise a switch, a router, a hub, a bridge, or any other network device that is configured to facilitate receiving, storing, processing, forwarding, and/or routing of packets.

The aggregation/distribution layer may comprise one or more network nodes 113. The network node 113 of the aggregation/distribution layer may route or otherwise relay data between the access layer. The core layer may comprise one or more network nodes 113 for routing or relaying data between the aggregation/distribution layer. Furthermore, the core layer may receive inbound data from a network 117 and route the incoming data throughout the core layer. The core layer may receive outbound data from the aggregation/distribution layer and route the outbound data to the network 117. Thus, the computing environment 100 may be in communication with a network 117 such as, for example, the Internet.

The computing environment 100 may further comprise a network state monitor 121. The network state monitor 121 may comprise one or more computing devices that are communicatively coupled to one or more network nodes 113 of the computing environment 100. The network state monitor 121 may be configured to execute one or more monitoring applications for identifying when packets are dropped in the computing environment 100.

The computing environment 100 is configured to generate, store, update, route, and forward packets 205. A packet may vary in size from a few bytes to many kilobytes. A packet 205 expresses information that may be formatted in the digital domain. For example, the packet 205 may include a series of 1's and 0's that represent information.

Next, a general description of the operation of the various components of the computing environment 100 is provided. To begin, the various servers 109 may be configured to execute one or more applications or jobs in a distributed manner. The servers 109 may receive input data formatted as packets 205. The packets 205 may be received by the server 109 from a network 117. The received packets 205 may be routed through one or more network nodes 113 and distributed to one or more servers 109. Thus, the servers 109 may process input data that is received via the network 117 to generate output data. The output data may be formatted as packets 205 and transmitted to various destinations within the computing environment 100 and/or outside the computing environment 100.

As the servers 109 execute various applications, packets 205 are switched from one network node 113 to the next network node 113 to reach a destination. The route a packet 205 takes in the computing environment 100 may be characterized as a multi-hop path. The computing environment 100 may include undesirable conditions that cause a packet 205 to experience corruption as it travels along a multi-hop path. Corruption may be caused by faulty wiring in the computing environment 100, electromagnetic interference, data noise introduced by a network node 113 or server 109, or any other undesired network abnormality. As a result, corruption causes the bits of a packet 205 to be altered in a manner that leads to an undesirable destruction of the data included in the packet 205. The source of the corruption may be attributed to a particular component in the computing environment 100. Various embodiments of the present disclosure relate to identifying the source of the corruption. Remedial action may be taken in response to identifying the corruption source.

The packet 205 may be handled in the computing environment 100 according to a particular scheme. According to a store-and-forward (SAF) scheme, the packet 205 is handled as an SAF packet 205 such that a network node 113 may receive the SAF packet. Thereafter, the network node 113 may store the SAF packet 205 in memory such as a packet buffer. In this respect, the network node 113 absorbs the entire SAF packet 205 and stores the entire SAF packet 205 in a memory. After the entire SAF is absorbed and stored, the network node 113 may process the SAF packet 205 and then forward the SAF packet 205 to the next network node 113. Processing the SAF packet 205 may involve performing error detection, packet scheduling, packet prioritization, or any other packet processing operation.

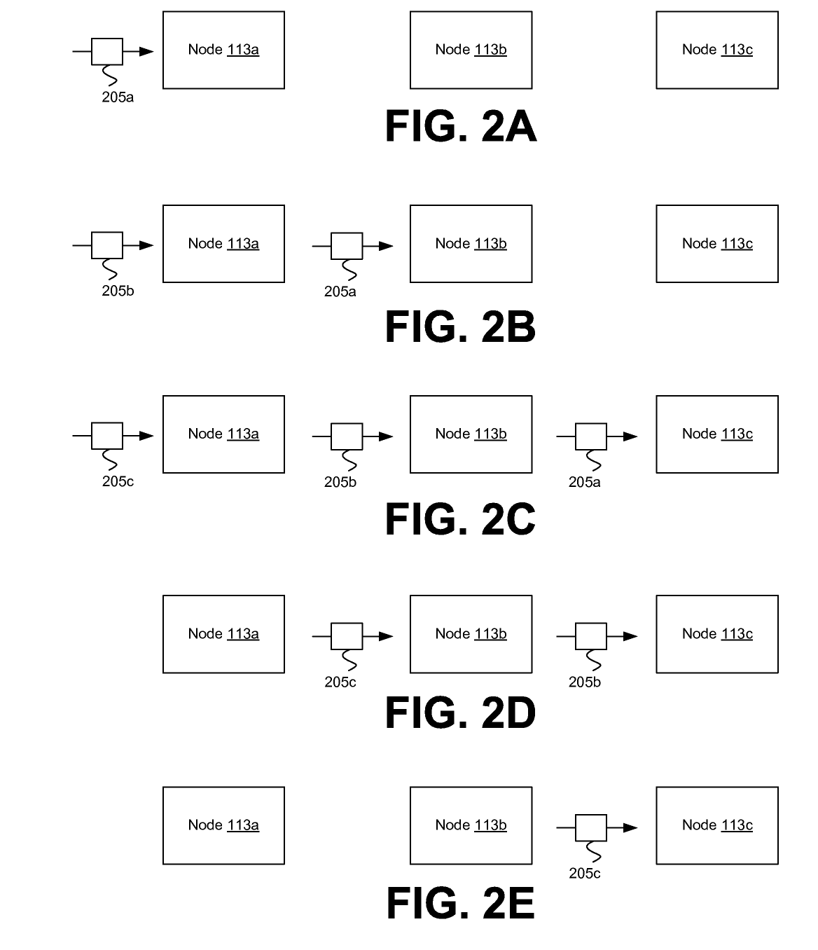

The packet 205 may be alternatively handled according to a cut-through (CT) scheme such that the packet 205 is handled as a CT packet 205. This is explained in further detail below with respect to at least FIGS. 2A-E.

In FIG. 2A, shown is an example of a packet 205 that is a cut-through type packet 205 that is transmitted via the computing environment 100 of FIG. 1, according to various embodiments of the present disclosure. A CT packet 205 is a packet that is received by a particular network node 113 and then forwarded to the next network node 113 before the particular network node 113 completely absorbs the CT packet 205. That is to say, a network node begins 113 forwarding a beginning portion of a CT packet 205 while the network node 113 is receiving an end portion of the CT packet 205.

Specifically, in the non-limiting example of FIG. 2A, a first network node 113a receives a first CT packet portion 205a. The first CT packet portion 205a may make up the first few bits of the CT packet 205. The CT packet 205 travels along a multi-hop path such that the CT packet 205 is transmitted from the first network node 113a to a second network node 113b and thereafter is transmitted from the second network node 113b to a third network node 113c.

In FIG. 2B, shown is an example of the packet 205 of FIG. 2A that is a cut-through type packet 205, according to various embodiments. Specifically, FIG. 2B depicts a CT packet 205 that is transmitted at a point in time that follows the point in time depicted in FIG. 2A. The CT packet 205 includes the first CT packet portion 205a and a second CT packet portion 205b. The second CT packet portion 205b may comprise bits that sequentially follow the bits included in the first CT packet portion 205a.

The first network node 113a receives the first CT packet portion 205a as discussed in FIG. 2A and, thereafter, forwards the first CT packet portion 205a to the second network node 113b. During or after the first network node 113a transmits the first CT packet portion 205a to the second network node 113b, the first network node 113a receives the second CT packet portion 205b. In this respect, the CT packet 205 is simultaneously handled by the first network node 113a and the second network node 113b.

In FIG. 2C, shown is an example of the packet 205 of FIGS. 2A and 2B that is a cut-through type packet 205, according to various embodiments. Specifically, FIG. 2C depicts a CT packet 205 that is transmitted at a point in time that follows the point in time depicted in FIG. 2B. The CT packet 205 includes the first CT packet portion 205a, a second CT packet portion 205b, and a third CT packet portion 205c. The third CT packet portion 205c may comprise bits that sequentially follow the bits included in the second CT packet portion 205b. Moreover, the third CT packet portion 205c may comprise the last bits of the CT packet 205.

The first network node 113a receives the third CT packet portion 205c while the second network node 113b receives the second CT packet portion 205b from the first network node 113a and while the third network node 113c receives the first packet portion 205a from the second network node 113b.

In FIG. 2D, shown is an example of the packet 205 of FIGS. 2A-C that is a cut-through type packet 205, according to various embodiments. Specifically, FIG. 2D depicts a CT packet 205 that is transmitted at a point in time that follows the point in time depicted in FIG. 2C.

The first network node 113a forwards the third CT packet portion 205c to the second network node 113b. The second network node 113b receives the third packet portion 205c while forwarding the second CT packet portion 205b to the third network node 113c. The point of time represented in FIG. 2D indicates that the first network node 113a has completely received and forwarded all portions of the CT packet 205.

In FIG. 2E, shown is an example of the packet 205 of FIGS. 2A-D that is a cut-through type packet 205, according to various embodiments. Specifically, FIG. 2E depicts a CT packet 205 that is transmitted at a point in time that follows the point in time depicted in FIG. 2D.

The second network node 113b forwards the third CT packet portion 205c to the third network node 113c. The point in time represented in FIG. 2E indicates that the second network node 113b has completely received and forwarded all portions of the CT packet 205.

The non-limiting examples of FIGS. 2A-E depict handling a packet 205 as a CT packet. If the packet 205 was handled as an SAF packet, then typically all portions of the SAF packet 205 would be received by a particular network node 113 before that particular network node 113 begins forwarding the SAF to the next network node 113.

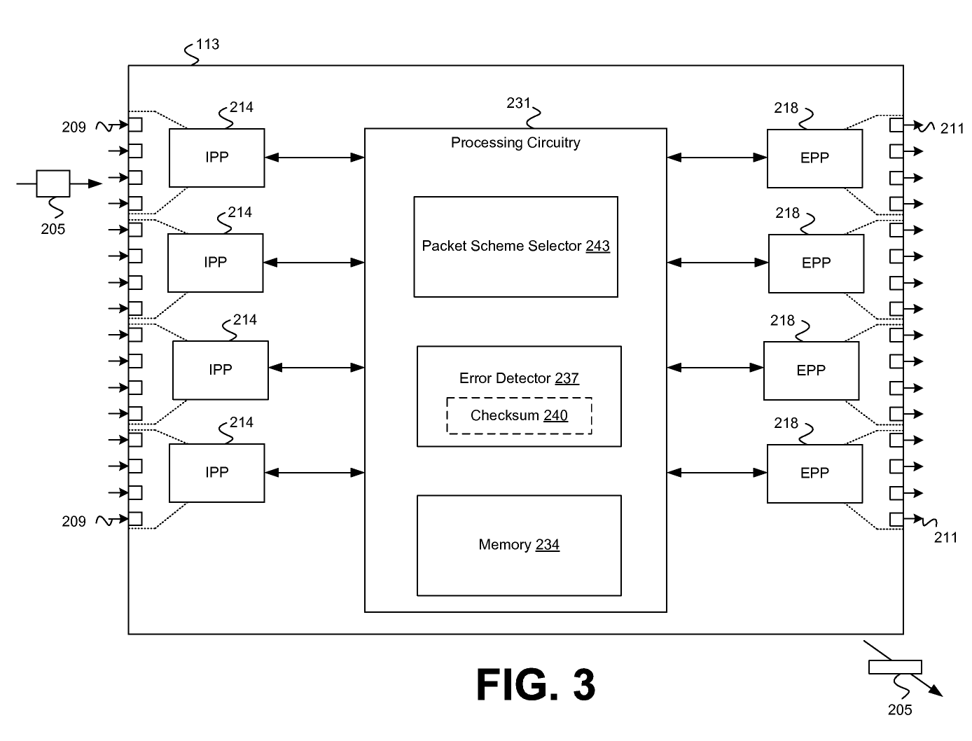

With regard to FIG. 3, shown is a drawing of an example of a network node 113 implemented in the computing environment 100 of FIG. 1, according to various embodiments of the present disclosure. The network node 113 depicted in the non-limiting example of FIG. 3 may represent any network node 113 of FIG. 1.

The network node 113 may correspond to a switch, a router, a hub, a bridge, or any other network device that is configured to facilitate the receiving, routing and forwarding of packets 205. The network node 113 is configured to receive a packet 205 from a source and route the packet to or from a destination. The network node 113 may comprise one or more input ports 209 that are configured to receive one or more packets 205. The network node 113 also comprises a plurality of output ports 211. The network node 113 may perform various operations such as prioritization and/or scheduling for routing a packet 205 from one or more input ports 209 to one or more output ports 211.

The network node 113 may be configured to handle the packet 205 as an SAF packet, as a CT packet, or as either an SAF packet or as a CT packet. The time it takes for a packet 205 to flow through at least a portion of the network node 113 may be referred to as a “packet delay.” The packet delay under an SAF scheme may be greater than the packet delay under a CT scheme because the SAF scheme may require that the entire packet 205 be received before the packet 205 is forwarded.

The network node 113 comprises one or more ingress packet processors 214. Each ingress packet processor 214 may be configured to be bound to a subset of input ports 209. In this sense, an ingress packet processor 214 corresponds to a respective input port set. In addition to associating an incoming packet to an input port set, the ingress packet processors 214 may be configured to process the incoming packet 205.

The network node 113 also comprises one or more egress packet processors 218. An egress packet processor 218 may be configured to be bound to a subset of output ports 211. In this sense, each egress packet processor 218 corresponds to a respective output port set. In addition to associating an outgoing packet to an output port set, the egress packet processors 218 may be configured to process the outgoing packet 205.

Inbound packets 205, such as those packets received by the input ports 209, are processed by processing circuitry 231. In various embodiments, the processing circuitry 231 is implemented as at least a portion of a microprocessor. The processing circuitry 231 may include one or more circuits, one or more processors, application specific integrated circuits, dedicated hardware, digital signal processors, microcomputers, central processing units, field programmable gate arrays, programmable logic devices, state machines, or any combination thereof. In yet other embodiments, processing circuitry 231 may include one or more software modules executable within one or more processing circuits. The processing circuitry 231 may further include memory 234 configured to store instructions and/or code that causes the processing circuitry 231 to execute data communication functions.

In various embodiments the processing circuitry 231 may be configured to prioritize, schedule, or otherwise facilitate a routing of incoming packets 205 to one or more output ports 211. The processing circuitry 231 receives a packet 205 from one or more ingress packet processor 214. The processing circuitry 231 may perform operations such as packet scheduling and/or prioritization of a received packet 205. To this end, the processing circuitry 231 may comprise a traffic manager for managing network traffic through the network node 113.

To execute the functionality of the processing circuitry 231, a memory 234 may be utilized. For example, the processing circuitry 231 may comprise memory 234 for storing packets 205. In an SAF scheme, the memory 234 may be used to store the entire inbound packet 205 before the packet 205 is transmitted to the next network node 113.

After a packet 205 has been processed, the processing circuitry 231 sends the packet 205 to one or more egress packet processors 218 for transmitting the packet 205 via one or more output ports 211. To this end, the processing circuitry 231 is communicatively coupled to one or more ingress packet processors 214 and one or more egress packet processors 218. Although a number of ports/port sets are depicted in the example of FIG. 3, various embodiments are not so limited. Any number of ports and/port sets may be utilized by the network node 113.

The processing circuitry 231 may include an error detector 237 for detecting whether the received packet 205 has been corrupted. The error detector 237 may execute an error detection operation such as, for example, a cyclic redundancy check (CRC). To detect an error, the packet 205 may include a frame check sequence that indicates a predetermined checksum. Before the packet 205 is received a frame check sequence is generated for the packet 205 using an error detection algorithm such as CRC or any other hash function. The error detector 237 performs the error detection operation to generate a checksum 240. The checksum 240 is compared to the frame check sequence to determine whether a mismatch exists. If there is no mismatch, then it may be the case that the packet 205 was received without corruption. In other words, if the frame check sequence matches the checksum 240, then it may be deemed that the received data of the packet 205 is accurate and not corrupted. However, if there is a mismatch between the frame check sequence and the checksum 240, then corruption may have occurred such that the bits contained in the packet 205 have been undesirably altered.

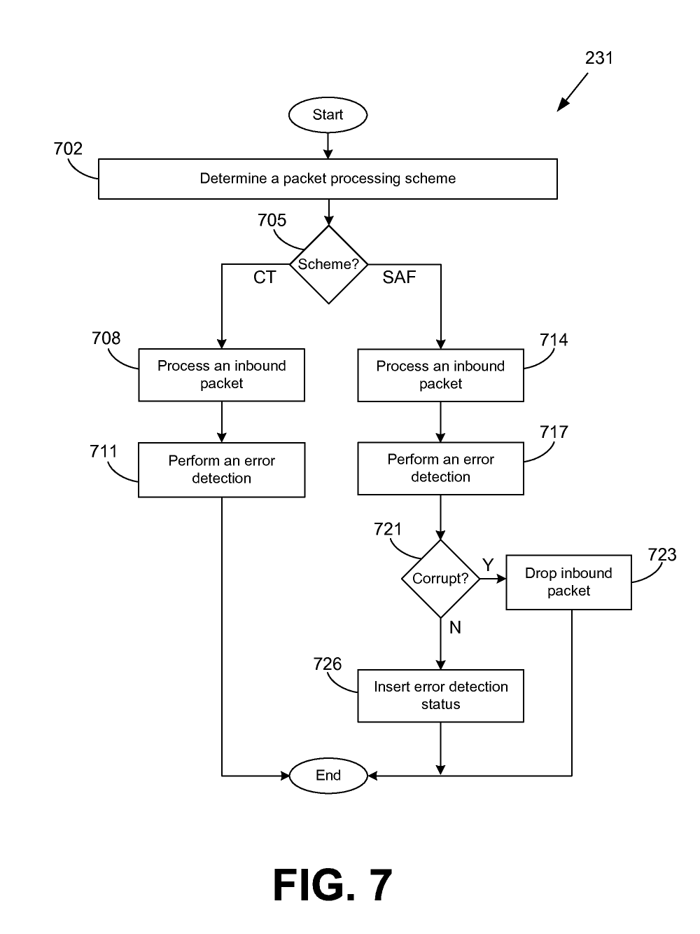

According to some embodiments, the processing circuitry 231 includes a packet scheme selector 243. The packet scheme selector 243 determines whether to handle the packet 205 as a CT packet or an SAF packet. The functionality of the packet scheme selector is discussed in further detail below with respect to at least FIG. 7.

### Including a Debug Indicator in Cut-Through Packets for Corruption Source Identification

The following is a general description of the operation of the various components of the network node 113 that allow for identifying a source of corruption using debug indicators. The computing environment 100 may be configured to accommodate CT packets while allowing for identification of a source of corruption. The network node 113 may receive packets 205 that are handled as CT packets. The network node 113 may initiate an error check operation using the error detector 237. The error detector 237 may perform the error detector operation on portions of a CT packet 205 as the CT packet is by the network node 113. In this respect, a running error detection operation is initiated before the CT packet 205 is completely received by the network node 113. Thus, the error detector 237 begins calculating the checksum 240 while the CT packet 205 is being received. The error detector 237 may complete the calculation of the checksum 240 after the CT packet 205 is completely received.

The CT packet 205 includes a frame check sequence. The error detector compares the checksum 240 of the CT packet 205 to the frame check sequence included in the CT packet 205 to determine whether the data of the CT packet 205 has been corrupted. If there is no corruption (i.e., the frame check sequence matches the checksum 240), then no action is taken.

If there is a mismatch between the checksum 240 and the frame check sequence, then the processing circuitry 231 may generate a debug indicator to indicate that the CT packet 205 is corrupted. The processing circuitry 231 may insert the debug indicator into the CT packet 205. The debug indicator may be a tag, a signature, or any additional packet data inserted into the CT packet 205. The debug indicator is used to record the instance where corruption is first identified as the CT packet 205 travels along a multi-node path. In some embodiments, the processing circuitry 231 may insert the debug indicator by replacing the frame check sequence with the debug indicator. In this case, the size of the debug indicator equals the size of the frame check sequence. By replacing the frame check sequence with the debug indicator, the overall size of the CT packet may remain unchanged. In other embodiments, the debug indicator is inserted into the CT packet to supplement the CT packet as a packet addition. In this case, the CT packet size may increase with the addition of the debug indicator.

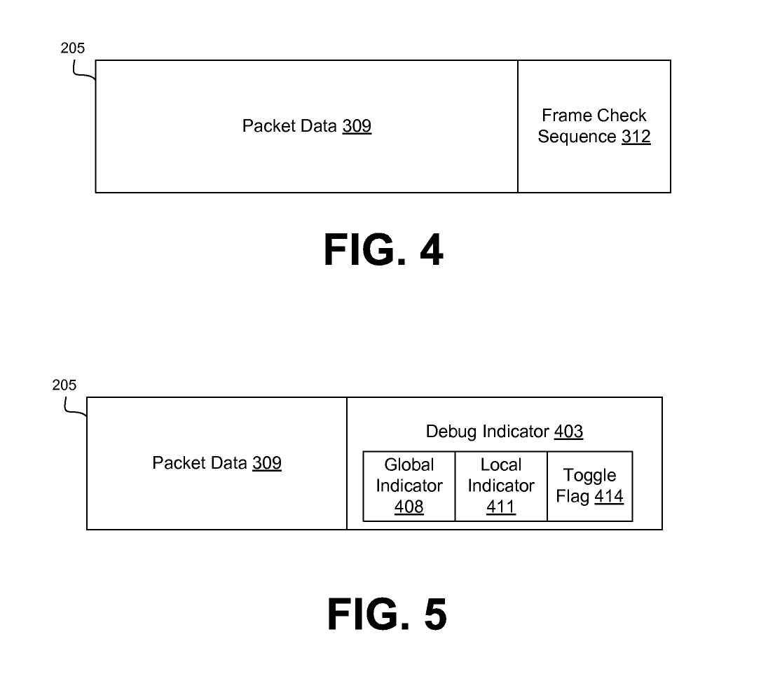

With reference to FIG. 4, shown is a drawing of an example of data included in a packet 205 transmitted via the computing environment 100 of FIG. 1, according to various embodiments of the present disclosure. Specifically, the non-limiting example of FIG. 4 may depict a packet 205 that is received by a network node 113 (FIG. 1). The packet 205 may be a CT packet or an SAF packet. The packet 205 includes packet data 309 and a frame check sequence 312. The packet data 309 may include substantive data such as a payload that is generated by a server application or that is destined to be received by a server application. The packet data 309 may also comprise other fields such as a packet header, a packet preamble, a destination address, a source address, any other control information, or any combination thereof.

The frame check sequence 312 is generated prior to the packet 205 being received by the network node 113. The frame check sequence 312 may be generated according to an error detection function that is used to verify whether the packet 205, as received by the network node 113, has been corrupted. The frame check sequence 312 is a value included in a frame check sequence frame. The frame check sequence frame may be positioned in the CT packet 205 according to a packet format protocol used by the various components in the computing environment 100 (FIG. 1).

With reference to FIG. 5, shown is a drawing of an example of data included in a packet 205 transmitted via the computing environment 100 of FIG. 1, according to various embodiments of the present disclosure. Specifically, the non-limiting example of FIG. 5 depicts a packet 205 that is processed by a network node 113 (FIG. 1) in response to detecting corruption in the packet 205. The packet 205 is a CT packet. The CT packet 205 includes packet data 309 and a debug indicator 403.

The processing circuitry 231 (FIG. 3) of a network node 113 (FIG. 3) may use an error detector 237 (FIG. 3) to determine whether a CT packet 205 received by the network node 113 is corrupted. The error detector 237 performs an error detection operation that generates a checksum 240 (FIG. 3) for the CT packet 205 while the CT packet 205 is received in portions. If then checksum 240 matches the frame check sequence 312 (FIG. 4) of the CT packet 205, then no corruption is detected.

However, if the checksum 240 mismatches the frame check sequence 312, then it is deemed that the CT packet 205 is corrupted. In response to detecting corruption of the CT packet 205, the processing circuitry 231 generates a debug indicator 403 that signals that the CT packet 205 is corrupted.

The debug indicator 403 may include a global indicator 408, a local indicator 411, a toggle flag 414, or any other information used to identify a source of corruption. The global indicator 408 is a signature that indicates to the various components in a computing environment 100 (FIG. 1) that the CT packet 205 is corrupted. The global indicator 408 may be a predetermined value used by any of the network nodes 113 in the computing environment 100. In other words, the global indicator 408 may be a universal value that is associated with the network nodes 113 that make up the multi-hop path of the CT packet 205. There may be one or more next network nodes 113 along the multi-hop path that follow the particular network node 113 that initially detected corruption. These one or more next network nodes 113 may determine that corruption was previously detected based on identifying that a global indicator 408 is included in the CT packet 205.

The debug indicator 403 may also include a local indicator 411. The local indicator 411 may be a value that is dedicated to a particular network node 113. The local indicator 411 may be a unique identifier that corresponds to a network node 113 such that a network administrator may identify the specific network node 113 based on the local indicator 411. In response to detecting corruption, the network node 113 may insert the local indicator 411 into the CT packet 205 to allow a network administrator to identify which network node 113 initially detected the corruption.

The processing circuitry 231 may insert the debug indicator 403 into the CT packet 205 in response to detecting corruption. One or more next network nodes 113 may determine that corruption was previously detected based on the global indicator 408 and determine which network node 113 initially detected the corruption based on the local indicator 411.

In some embodiments, the processing circuitry 231 may insert the debug indicator 403 into the CT packet 205 by replacing the frame check sequence 312 with the debug indicator 403. By replacing the frame check sequence 312 with the debug indicator 403, the CT packet frame format may not need to be appended or adjusted. However, by effectively overriding the frame check sequence 312, it is likely that the one or more next network nodes 113 will determine a mismatch between the generated checksum 240 and the value in the frame check sequence frame, where the value of the frame check sequence frame was previously replaced with the debug indicator 403. However, because the global indicator 408 is included in the frame check sequence frame, one or more next network nodes 113 may determine that the corruption was previously detected.

It is statistically possible that the debug indicator 403 is equal to the checksum value 240. The consequence of this is that a next network node 113 or network administrator will be unable to differentiate between an inserted debug indicator 403 and the next node's 113 calculated checksum 240. According to various embodiments, to address this situation, a toggle flag 414 may be used by the particular network node 113 that initially detects corruption. This particular network node 113 sets the toggle flag 414 to specify whether the debug indicator 403 is equal to the checksum 240.

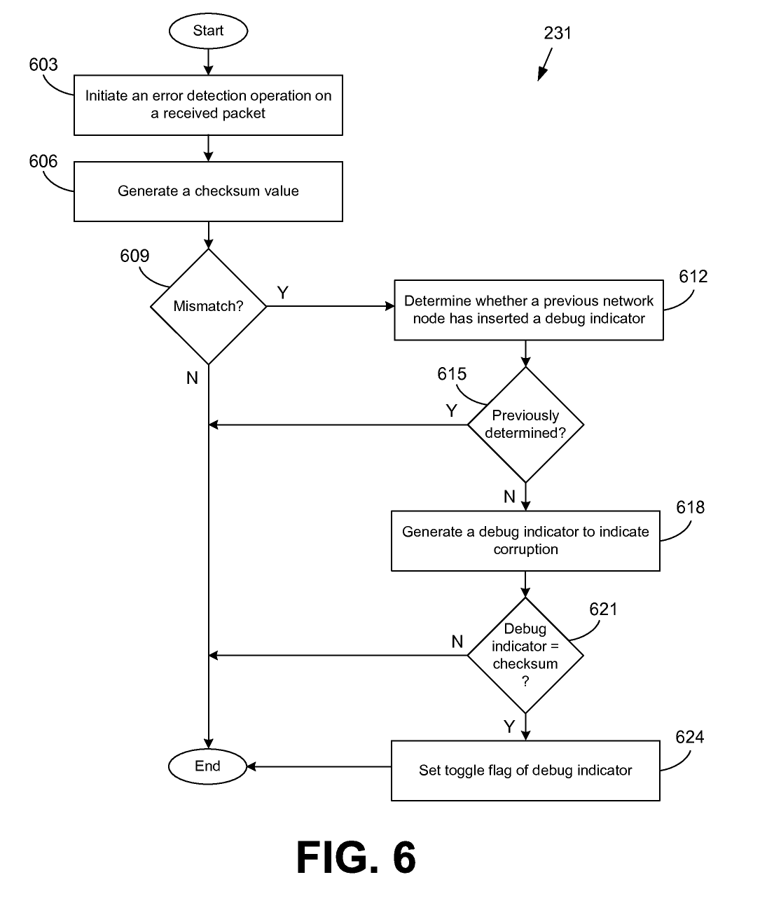

Turning now to FIG. 6, shown is a flowchart that provides an example of operation of a portion of the logic executed by the processing circuitry 231, according to various embodiments. It is understood that the flowchart of FIG. 6 provides merely an example of the many different types of functional arrangements that may be employed to implement the operation of the portion of the logic executed by the processing circuitry 231 as described herein. As an alternative, the flowchart of FIG. 6 may be viewed as depicting an example of steps of a method implemented in the processing circuitry 231 according to one or more embodiments. Specifically, FIG. 6 provides a non-limiting example of identifying a source of corruption for a network node 113 (FIG. 1) that handles CT packets 205 (FIG. 2).

To begin, at 603, the processing circuitry 231 initiates an error detection operation on a received packet 205. According to various embodiments, the packet is a CT packet 205. The processing circuitry may use an error detector 237 (FIG. 3) to execute an error detection operation. The error detection operation is initiated such that the operation is performed on the CT packet 205 before the CT packet 205 is completely received by the network node 113. The CT packet 205 includes a frame check sequence 312 (FIG. 4). Put another way, a running error detection operation is performed on the CT packet 205 as the CT packet is received portion by portion. Thus, the processing circuitry 231 may initiate the error detection operation independent of when the frame check sequence 312 of the CT packet 205 is received by the network node 113.

At 606, the processing circuitry 231 generates a checksum 240 (FIG. 3). The error detection operation is complete upon the network node 113 receiving the entire CT packet 205 including the frame check sequence 312 of the CT packet 205. The checksum 240 is generated by the error detector 237, which may use CRC or any other error detection function to generate the checksum 240.

At 609, the processing circuitry 231 compares the checksum 240 to the frame check sequence 312 to determine whether the CT packet may be corrupted. If there is no mismatch between the checksum 240 and the frame check sequence 312, the flowchart ends. It is noted that the CT packet 205 is forwarded to the next network node 113 at any point in time regardless of whether the CT packet 205 is corrupted.

At 612, if there is a mismatch between the checksum 240 and the frame check sequence 312, then the processing circuitry 231 determines whether a previous network node 113 has inserted the debug indicator 403 (FIG. 5) into the CT packet 205. As the CT packet 205 is transmitted from a previous network node 113 to the instant network node 113, it may be the case that the previous network node 113 has identified that the CT packet 205 is corrupted. The previous network node 113 may have inserted a debug indicator 403 into the CT packet 205 to signal to the instant network node 113, as well as other network nodes 113, that the corruption has been identified. Thus, the instant network node 113 may identify whether the debug indicator 403 or a portion thereof is included in the CT packet 205.

At 615, if the debug indicator 403 or a portion thereof is included in the CT packet 205, then the flowchart ends. This reflects the fact that the instant network node 113 is not the first network node 113 to determine that the CT packet 205 is corrupted. However, if the debug indicator 403 or a portion thereof is not included in the CT packet 205, then the CT packet 205 is the first network node to determine that the CT packet 205 is corrupted. Accordingly, the flowchart branches to 618.

At 618, the processing circuitry generates a debug indicator 403 to indicate corruption of the CT packet 205. The debug indicator 403 may signal to other network nodes 113 that corruption has been detected and additionally, the debug indicator 403 may specify the identity of the network node 113 in order to determine a source of the corruption.

At 621, if the generated debug indicator 403 is the same as the checksum 240 calculated by the processing circuitry 231, then the processing circuitry, at 624, sets the toggle flag 414 of the debug indicator 403. The processing circuitry 231 may insert the debug indicator 403 into the CT packet 205 as discussed above in the non-limiting example of FIG. 5. Inserting the debug indicator 403 into the CT packet 205 may comprise replacing a portion (e.g., the frame check sequence) of the CT packet 205 or supplementing the CT packet 205 with the debug indicator. However, if the generated debug indicator 403 is not equal to the checksum 240, then the processing circuitry does not set the toggle flag 414.

### Handling Inbound Packets Using Either a Cut-Through Scheme or a Store-and-Forward Scheme to Provide Corruption Source Identification

The following is a general description of the operation of the various components of a network node 113 (FIG. 2) that allow for identifying a source of corruption. Specifically, a network node 113 that is configured to process cut-through packets may force some cut-through packets to be handled as store-and-forward packets.

Referring to FIG. 7, shown is a flowchart that provides one example of another operation of a portion of the logic executed by the processing circuitry 231 of a network node 113 (FIG. 1), according to various embodiments. It is understood that the flowchart of FIG. 7 provides merely an example of the many different types of functional arrangements that may be employed to implement the operation of the portion of the logic executed by the processing circuitry 231 as described herein. As an alternative, the flowchart of FIG. 7 may be viewed as depicting an example of steps of a method implemented in the processing circuitry 231 according to one or more embodiments.

Specifically, FIG. 7 provides a non-limiting example of processing circuitry 231 that includes a packet scheme selector 243 (FIG. 3). The packet scheme selector 243 may be used in conjunction with the operations discussed above with respect to FIG. 6 or it may be used as an alternative to the operations discussed above with respect to FIG. 6. The packet scheme selector 243 is used to determine a source of corruption. However, the packet scheme selector 243 does not necessarily use the debug indicator 403 (FIG. 5) to identify the corruption source. Instead, the packet scheme selector 243 component of the processing circuitry 231 allows the network node 113 to handle a packet 205 (FIG. 2) as either an SAF packet or a CT packet. Error detection is performed at least on the packets 205 that are handled as SAF packets. By performing some error detection, the source of corruption may be identified. The following is a description of the processing circuitry 231 that uses a packet scheme selector 243 to determine the source of corruption, according to some embodiments.

To begin, at 702, the processing circuitry 231 determines a packet processing scheme. The packet processing scheme may be a cut-through (CT) packet processing scheme or a store-and-forward (SAF) packet processing scheme. In some embodiments, the packet processing scheme is determined according to an outcome of a number generator. The number generator comprises a deterministic random bit generator that generates the outcome according to a predefined probability. The predefined probability may be static or adjustable to control the percentage of packets 205 that are handled as CT packets 205 or SAF packets 205. Thus, the packet processing scheme may be selected randomly where the probability for an outcome is predetermined.

In other embodiments, the processing circuitry 231 determines a packet processing scheme by selecting 1 out of N inbound packets 205 to be handled as an SAF packet. For example, if N=5, then one out of five sequential inbound packets are handled according to an SAF scheme while the other four packets are handled according to a CT scheme.

In other embodiments, the inbound packet 205 may be marked to specify how the inbound packet is to be handled. The inbound packet 205 may include a marker that corresponds to an SAF scheme or a CT scheme. Thus, the packet scheme selector 243 determines which packet processing scheme to apply to the inbound packet 205 according to the marker included in the inbound packet 205.

It may be the case that CT packets 205 have less packet delay because a network node 113 that receives a CT packet 205 may begin transmitting the CT packet 205 to the next network node 113 before the CT packet 205 is completely received by the network node 113. On the other hand, it may be desirable to perform error detection on SAF packets 205 because an SAF packet 205 may be dropped or otherwise flagged if an error is detected. Thus, it may be easier to identify a corruption source for an SAF packet 205. Accordingly, in the case where the packet processing scheme is selected by a predefined probability or by a value of N, the predefined probability or the value of N may be optimized to allow a significant percentage of packets 205 to be handled as CT packets.

At 705, the processing circuitry 231 uses a packet scheme selector 243 to select the scheme to be a CT scheme or an SAF scheme. If the packet scheme selector 243 selects a CT scheme, then the inbound packet 205 is handled as a CT packet 205 and the flowchart branches to 708.

At 708, the processing circuitry 231 processes the inbound packet 205 according to a CT scheme. In this respect, the processing circuitry 231 forwards a beginning portion of the inbound packet 205 to a next network node 113 before an ending portion of the inbound packet 205 is received by the network node 113.

At 711, in some embodiments, the processing circuitry 231 may perform error detection on the inbound CT packet 205. At least some of the functionality depicted in FIG. 6 may be used to perform error detection on the CT packet 205. In other embodiments, no error detection is performed on CT packets 205.

At 705, if the packet scheme selector 243 selects an SAF scheme, then the inbound packet 205 is handled as an SAF packet 205 and the flowchart branches to 714. At 714, the processing circuitry 231 processes the inbound packet 205 according to an SAF scheme. In this respect, the processing circuitry 231 stores the inbound SAF packet 205 in the memory 234 (FIG. 3). The complete SAF packet 205 is stored before the processing circuitry 231 processes the SAF packet 205.

At 717, the processing circuitry 231 performs error detection on the stored SAF packet 205. The error detector 237 may calculate a checksum 240 (FIG. 3) and compare that checksum 240 to the frame check sequence 312 (FIG. 4) included in the SAF packet 205. At 721, if an error is detected indicating that the SAF packet 205 is corrupted, then the flowchart branches to 723.

At 723, the processing circuitry 231 drops the corrupted SAF packet 205. The processing circuitry 231 may send a message to a network state monitor 121 (FIG. 1) or any other network administrator indicating that a corrupt packet was detected. The processing circuitry 231 may update a data log indicating that a corrupt packet was detected. Because the SAF packet 205 is dropped, a network administrator may determine the immediate instance when a packet is determined to be corrupted. This allows for identification of a source of corruption.

If there is no corruption, then the flowchart branches to 726. At 726, the processing circuitry 231 inserts an error detection status into the SAF packet 205. The error detection status indicates that the error detection operation was performed. This information may be used to determine a source of corruption if that SAF packet 205 were to later become corrupted downstream. According to some embodiments, the error detection status may be inserted into unused portions of the packet header. The error detection status may also indicate that the inbound packet 205 was handled as an SAF packet. Thereafter, the processing circuitry 231 forwards the SAF packet 205 to the next network node 113.

According to various embodiments, the predetermined probability may be adjusted according to the size of the inbound packet or it may relate to the number of instances when a particular network node 113 detected corruption. The probability may be dynamically adjusted when the network node 113 detects corruption or it may be set manually by a network administrator.

The flowcharts of FIGS. 6-7 show the functionality and operation of an implementation of portions of the processing circuitry 231 implemented in a network node 113 (FIG. 1). If embodied in software, each reference number, represented as a block, may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowcharts of FIGS. 6-7 a specific order of execution, it is understood that the order of execution may differ from that which is depicted. For example, the order of execution of two or more blocks may be scrambled relative to the order shown. Also, two or more blocks shown in succession in FIGS. 6-7 may be executed concurrently or with partial concurrence. Further, in some embodiments, one or more of the blocks shown in FIGS. 6-7 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the processing circuitry 231, that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A network node comprising:
processing circuitry, the processing circuitry being operable to:
perform a running error detection operation on a cut-through packet received by the processing circuitry to generate a checksum value;
determine whether a previous network node inserted a debug indicator into the cut-through packet in response to detecting a mismatch between the checksum value and a frame check sequence included in the cut-through packet; and
forward the cut-through packet to a next network node.

2. The network node of claim 1, wherein the processing circuitry is further operable to insert the debug indicator in response to detecting the mismatch between the checksum value and the frame check sequence and further in response to determining whether the previous network node has inserted the debug indicator into the cut-through packet.

3. The network node of claim 2, wherein the processing circuitry is further operable to insert the debug indicator into the cut-through packet by replacing the frame check sequence with the debug indicator.

4. The network node of claim 1, wherein the debug indicator comprises a global indicator that indicates that the cut-through packet is corrupted, the global indicator being associated with the previous network node, the network node, and the next network node.

5. The network node of claim 1, wherein the debug indicator comprises a local indicator that is specific to the network node.

6. The network node of claim 1, wherein the debug indicator comprises a toggle flag specifying whether the debug indicator is equal to the checksum value.

7. A system comprising:
processing circuitry implemented in a network node, the processing circuitry comprising:
circuitry that initiates an error detection operation on a portion of a packet received by the network node to generate a checksum value;
circuitry that determines whether to insert a debug indicator into the packet in response to comparing the checksum value to a frame check sequence included in the packet; and
circuitry that forwards the portion of the packet to a next network node.

8. The system of claim 7, wherein the packet comprises a cut-through packet, wherein the circuitry that initiates the error detection operation comprises circuitry that initiates the error detection operation independent of when the frame check sequence of the packet is received by the network node.

9. The system of claim 7, wherein the processing circuitry further comprises circuitry that inserts the debug indicator into the packet by replacing the frame check sequence with the debug indicator.

10. The system of claim 7, wherein the debug indicator comprises a global indicator that indicates that the packet is corrupted, the global indicator being associated with a plurality of network nodes including the network node and the next network node.

11. The system of claim 10, wherein the processing circuitry further comprises circuitry that determines whether to insert the debug indicator into the packet further in response to determining whether a previous network node has inserted the global indicator into the packet.

12. The system of claim 10, wherein the debug indicator further comprises a local indicator that is specific to the network node.

13. The system of claim 7, wherein the debug indicator further comprises a toggle flag specifying whether the debug indicator is equal to the checksum value.

14. A method comprising:
determining a packet processing scheme, the packet processing scheme being one of a cut-through packet processing scheme or a store-and-forward packet processing scheme;
processing an inbound packet in a network node according to the packet processing scheme; and
performing an error detection operation on the inbound packet in response to the packet processing scheme being the store-and-forward packet processing scheme.

15. The method of claim 14, wherein the cut-through packet processing scheme comprises forwarding a first portion of the inbound packet to a next network node before a second portion of the inbound packet is received by the network node.

16. The method of claim 14, wherein the store-and-forward packet processing scheme comprises storing the inbound packet before forwarding the inbound packet to a next network node.

17. The method of claim 14, further comprising determining the packet processing scheme according to an outcome of a number generator, wherein the number generator comprises a deterministic random bit generator that generates the outcome according to a predefined probability.

18. The method of claim 17, further comprising adjusting the predefined probability in response to detecting an error by performing the error detection operation.

19. The method of claim 17, wherein the predefined probability is based on the size of the inbound packet.

20. The method of claim 17, further comprising inserting an error detection status into the inbound packet in response to processing the inbound packet according to the store-and-forward packet processing scheme, the error detection status indicating that the error detection operation was performed.
